(19) United States
(12) Patent Application Publication
(10) Pub. No.: US 2022/0402559 A1
(43) Pub. Date: Dec. 22, 2022

(54) A ZERO EMISSION VEHICLE WITH A SKATEBOARD PLATFORM OR SKATEBOARD CHASSIS AND A BODY

(71) Applicant: ARRIVAL LIMITED, London (GB)

(72) Inventors: Joe Allum, London (GB); Patrick Bion, London (GB)

(21) Appl. No.: 17/778,161

(22) PCT Filed: Nov. 18, 2020
(86) PCT No.: PCT/GB2020/052943

§ 371 Date: May 19, 2022

(30) Foreign Application Priority Data
Nov. 19, 2019 (EP) 19210147.5

(51) Int. Cl. B62D 25/20; B62D 31/02; B62D 25/02; B62D 27/02; B62D 65/02

(52) U.S. Cl. CPC B62D 25/2036; B62D 31/02; B62D 25/02; B62D 27/023; B62D 27/026; B62D 65/02

(57) ABSTRACT

An automotive vehicle has a skateboard platform and a vehicle body that is attached to the skateboard platform or chassis. The sides of the vehicle body are formed using a structural frame, made up of multiple structural sub-frames that give structural integrity to the sides of the vehicle body and to which body panels are attached. Each structural sub-frame is directly attached to the skateboard platform or chassis.

### FIELD OF THE INVENTION

The present disclosure relates to a zero emission vehicle, such as an electric or fuel cell van, bus or car, with a skateboard platform or skateboard chassis and a body. The term ‘skateboard platform or skateboard chassis’ should be expansively construed to cover any vehicle chassis or underbody in which the power train is low and substantially flat (e.g. there is a low and flat electric battery pack or fuel cell, and there are compact electric traction motors as opposed to a bulky internal combustion engine, and there are drive-by-wire accelerator, brakes and steering systems. Skateboard platforms are widely used in the electric vehicle sector; very different bodies can be readily designed to sit on the same skateboard platform, since the skateboard platform imposes far fewer requirements on the design of the external body shell and the internal configuration of everything inside the body, compared to conventional, monocoque vehicle platforms. The battery pack in a skateboard platform can provide or substantially contribute to the structural integrity of the platform; alternatively, the battery pack can be enclosed within and be supported by an external rigid structure.

### BACKGROUND

In designing electric vehicles, established automotive manufacturers often carry over engineering thinking from their experience of conventional vehicles powered by internal combustion engines (ICEs). This makes sense. These large manufacturers have spent many years and often billions of dollars in the research and development of methodologies, technologies and components for these conventional vehicles. Many of them have been hugely successful in this. Reusing that work when developing and manufacturing electric vehicles is therefore less expensive and quicker than doing this all again. This approach is encouraged by having have workforces of tens or hundreds of thousands of people, established R&D centres and vast manufacturing facilities that for years have been focussed on optimising the design and manufacture of these conventionally powered vehicles.

There are however problems with this. Engineering thinking and technologies that are optimised for vehicles powered by ICEs are not necessarily optimised for electric vehicles. The different powertrains have different characteristics. By using engineering thinking in an electric vehicle that is optimised for the legacy ICE powertrain, the resulting vehicle will almost inevitably be much like the vehicle it seeks to replace. It will not make full use of the characteristics of the electric powertrain. It will not be optimised.

International Application No. PCT/GB2018/052415 describes one area in which established, legacy thinking has been resisted and, instead, fresh thinking has been brought to the design of electric vehicles. (The technology described in that application was developed by the same organisation as the technology described in the present disclosure.)

PCT/GB2018/052415 describes a chassis for an electric vehicle, which is perhaps better considered an ‘underbody’ of the vehicle. The underbody described in PCT/GB2018/052415, which is shown at 100 in FIGS. 2 and 3 of that document, has an upper side and a lower side. These two sides are spaced apart to create a cavity between them. The cavity is used to accommodate the electric powertrain of the vehicle. In this way, the powertrain is contained within the underbody.

This approach makes good use of the characteristics of the electric power train. By accommodating the powertrain within a long, flat underbody that runs the length of the vehicle, there are several packaging, performance and manufacturing benefits. These are set out in PCT/GB2018/052415.

A problem remains, however, of how to provide a body for a vehicle of which an underbody such as that described in PCT/GB2018/052415 forms part. In particular, how should such a body be optimised to make best use of the potential of an electric powertrain? How should it be optimised to work with an underbody such as that described above? How should the two go together?

The General Motors AUTOnomy project from 2002 provides some useful insights: this was a hydrogen fuel cell powered autonomous car concept that proposed a ‘skateboard’ platform—i.e. flat-topped platform that housed the fuel-cell system and electric traction motors under a flat surface that ran the entire length of the vehicle. Set into the surface of this platform were four cylinders, placed approximately at the four corners of where the passenger compact cent would be, but some distance in from the edge or side of the skateboard platform; the idea was that different body types would all share a base with four pins that would each engage and lock into, as well as dis-engage and unlock from, one of these cylinders, docking and securing the body to the skateboard platform and also enabling the entire body to be lifted off the skateboard platform and replaced with a different body. The body would typically be a conventional pressed steel panel body, but with a lower flat surface that would rest on the skateboard platform; because the car designer was not restricted by the presence of an internal combustion engine, or the normal mechanical or electro-mechanical control linkages, some very futuristic body shapes were envisaged, such as the GM Hy-wire, shown in 2002; furthermore, the body was not permanently attached to the skateboard chassis; it was designed to be rapidly (e.g. 30 minutes) undocked and removed, and a different body lowered onto, docked and locked onto the skateboard platform. The AUTOnomy concept, whilst ahead of its time, nevertheless imposes design constraints: for example, attaching a pressed steel body to the skateboard at 4 pre-set mechanical connection points that could both lock and unlock, allowing the body to be lifted off and replaced with a different body, whilst conceptually elegant, is complex and costly to engineer in practice. Further details of the General

Motors AUTOnomy project can be found in US 2004/0069545.

### SUMMARY OF THE INVENTION

The invention is an automotive vehicle with a skateboard platform or skateboard chassis and a vehicle body that is attached to the skateboard platform or chassis, in which the sides of the vehicle body are formed using a structural frame, made up of multiple structural sub-frames that give structural integrity to the sides of the vehicle body and to which body panels are attached; and in which each structural sub-frame is directly attached to the skateboard platform or chassis.

One advantage of this approach is that it enables fast and reliable assembly of the structural sub-frames to the skateboard platform or chassis, such as fast and reliable automated assembly.

Further aspects, features and sub-features of the invention are summarised at Appendix 1.

### BRIEF DESCRIPTION OF DRAWINGS

Specific embodiments are described below in the Detailed Description by way of example only and with reference to the accompanying drawings. FIGS. 1-5 show one implementation; FIGS. 6-[11]] show a different implementation:

FIG. 1 shows, in perspective view, components of an electric van, including a structural body portion of a body of the van and an underbody chassis of the van;

FIG. 2 shows, in elevation, structural members the structural body portion;

FIG. 3 shows, in perspective view, detail of one of the members of the structural body portion;

FIG. 4 shows detail one of the members of the structural body portion and detail of the underbody chassis, the two components spaced apart from each other; and

FIG. 5 shows the components shown in FIG. 4 placed together and fixed to each other.

FIG. 6 shows a perspective view of the van, including the skateboard platform and the frame, made up of three sets of inverse U shaped structural sub-frames.

FIG. 7 shows a perspective view of the van, including the skateboard platform and the frame, and a single inverse U shaped structural sub-frames; close-ups views of how the feet attach directly to the skateboard platform are included and shown in enlarged size in FIGS. 8 and 9.

FIG. 10 shows the inverse U shaped structural sub-frame or hoop; front, top, bottom and side views are included.

FIG. 11 is a perspective view of the inverse U shaped structural sub-frame or hoop, with close-up views of the top or bow and also the foot.

FIGS. 12-17 are views of the foot of the inverse U shaped structural sub-frame or hoop.

### KEY TO THE NUMBERED FEATURES SHOWN IN THE FIGURES

underbody chassis or skateboard platform 10
structural members 100
underbody chassis or skateboard platform upper side 12
underbody chassis or skateboard platform outward facing side 13
underbody chassis or skateboard platform lower side 14
straight members of the frame that extend in the front-to-back direction 110
u-shaped members of the frame or structural sub-frames 120
foot section of a u-shaped member 122
top section of a u-shaped member 124
Straight pillar section of a u-shaped member 126
foot: flat top surface or base of the foot 130
foot: flat side surface or lip of the foot 132
foot: internal filet radius 134
foot: aperture to receive pillar section 135
foot: conical locating pin 136
foot: bolt through top surface 138
foot: male mounting structure 139
underbody: female mounting structure 149
female mounting structure: recessed top surface 140
female mounting structure: recessed side surface 142
female mounting structure: hole 146 in top surface to receive conical pin
female mounting structure: hole 148 to receive bolts 138

### DETAILED DESCRIPTION

This section will describe two implementations of the invention.

In general terms, the approach of the present solution is to provide parts of a vehicle body and parts of a vehicle underbody (an underbody, for example, as described in PCT/GB2018/052415) each with interfacing portions that interface to locate the vehicle body relative to the underbody and to provide the structural support for that body and hence for the vehicle.

In one implementation, we have an underbody chassis, the underbody chassis comprising an upper side and a lower side and containing, between the upper side and a lower side, at least one of a battery and an electric motor of an electric powertrain of the vehicle; and a structural body portion of a vehicle body for fixing directly to the underbody chassis; each of the structural body portion and the underbody chassis comprises a plurality of mounting structures, each mounting structure on the structural body portion arranged to mate with a respective mounting structure on the underbody chassis to form a direct attachment between the structural body portion and the underbody chassis. Direct attachment reduces the component count, for example eliminating the need for a separate connector system that is ancillary to the structural body portion.

By providing these features, it is possible to easily and quickly assemble the structural body portion and hence the vehicle body to the underbody chassis. Also, the underbody chassis is able to provide structural support for the vehicle body. Manufacturing and assembly costs and times are lower than with legacy approaches. The vehicle may comprise the vehicle body, as well as the structural body portion of the vehicle body.

The structural body portion may be arranged to support the body of the vehicle on the underbody chassis. It may also form at least part of the safety cell of the vehicle. The structural body portion may comprise a plurality of structural members. The structural members may form part or all of a frame of the body. The frame may be part or all of the safety cell of the vehicle. The vehicle body may comprise one or more body panels. The or each panel may be formed of composite material. The or each body panel may be fixed to the structural members. The or each panel may be partly structural. The vehicle body may be a monocoque. The monocoque may comprise the structural body portion that is for fixing to the underbody chassis. The structural body portion may be integrally formed with the rest of the monocoque. The monocoque may be a monocoque insofar as this is possible with a separate underbody chassis. The structural members may comprise some or all of the mounting structures of structural body portion. Those mounting structures may be formed in ends of the structural members. Those ends of the structural members may be formed as castings, the mounting structures being at least partly formed by that casting (with or without subsequent machining) Other parts of the mounting structures, or other mounting structures, may be formed by extrusions.

The mounting structures on the structural body portion and on the underbody chassis are located to locate the structural body portion (and thereby the vehicle body) relative to the underbody chassis when the respective structures mate. The mounting structures on the structural body portion and on the underbody chassis are profiled to provide structural support of the structural body portion and thereby the vehicle body) relative to the underbody chassis when the respective structures mate and when the structural body portion is fixed to the underbody chassis. The mounting structures on the structural body portion and the mounting structures on the underbody chassis may be profiled such that the mating mounting structures have substantially matching profiles to facilitate direct attachment. One of each mating pair of the mounting structures may have a male portion that is received in a female portion of the other of the mating pair. The male portion may be tapered from its base to its end to help with location during assembly. The female portion may be correspondingly tapered.

The vehicle (or a sub-assembly of a vehicle) may comprise fixing means to fix the structural body portion to the underbody chassis. The direct attachment fixing means may be mechanical and/or chemical fixing means. The direct attachment fixing means may be, for example, a fastener. The direct attachment fixing means may be, for example, an adhesive. The fixing means may be applied at the interface between each mating pair of mounting structures.

The underbody chassis may be a chassis substantially as described in PCT/GB2018/052415. The upper side of the underbody may be—or may substantially correspond to—an internal floor of the vehicle. The underbody chassis may contain the or each battery, and/or power electronics and/or control electronics and/or the or each motor of the electric powertrain of the vehicle. The underbody chassis may contain substantially all the components of the electric powertrain of the vehicle. The upper side of the underbody chassis may extend substantially between the front and the back of the vehicle and between its sides. The upper side may extend substantially to the front and the back of the vehicle and to each side. The upper side may be substantially flat. The upper side may extend between wheel arches of the vehicle. The upper side may extend between and around wheel arches of the vehicle. The upper side may not extend substantially to the front of the vehicle. The upper side may extend towards the front of the vehicle but be spaced therefrom.

The underbody chassis may comprise a plurality of modules, each module being a section of the underbody chassis. The sections may be longitudinal and/or transverse sections. The sections may fit together to form the underbody chassis. One or more of the sections may be substantially the same, for example as a result of being sections of the same extrusion or formed as castings from the same mould.

The mounting structures of the underbody chassis may be formed in structure of the underbody chassis or fixed thereto. The mounting structures of the underbody chassis may be formed in structure of the underbody chassis by casting. The mounting structures of the underbody chassis may be formed as castings in the cast sections of the underbody chassis.

The electric vehicle may be a commercial electric vehicle. It may be a vehicle for transporting cargo. It may be a vehicle for transporting people. It may be a bus. It may be a van. It may be a delivery van. It may be another type of commercial vehicle. It is envisaged that the electric vehicle is a wholly electric vehicle, that is, without an internal combustion engine either as a prime-mover or as a range-extender to be used to power a generator to generate electricity for charging batteries or powering a traction electric motor.

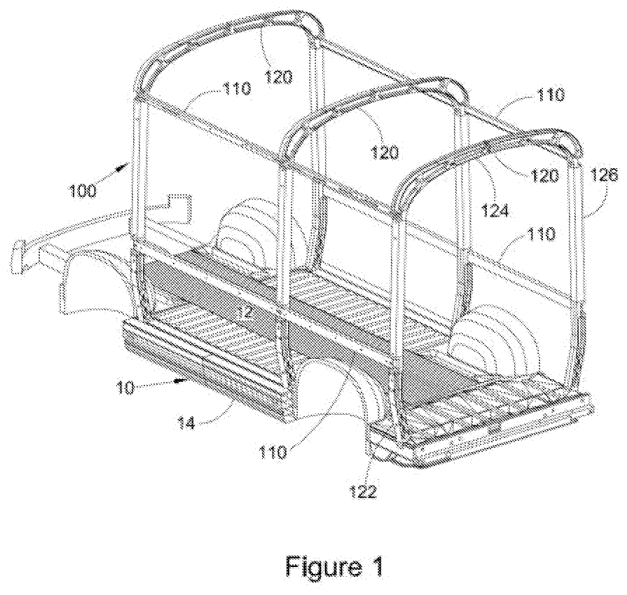

FIG. 1 shows components of an electric van. Only some components of the van are shown. Visible in FIG. 1 is an underbody chassis 10 of the van. Also shown is a structural body portion of a body of the van formed of several structural members 100.

The underbody chassis 10—which from here will be called simply the ‘underbody’— has as upper side 12 and a lower side (not visible, but indicated at 14). There is a cavity between the two sides. Components of the electric powertrain (not visible) of the van are housed in the cavity between the upper side 12 and the lower side 14. These components include the batteries, power electronics, control electronics for controlling the batteries and the power electronics, and electric drive motors.

As can be seen, the underbody 10 forms a low-profile base for the vehicle aligned generally in the plane of the axes of the vehicle's wheels. It looks a bit like a skateboard, but with a thicker ‘board’ to accommodate the electric powertrain. This has several packaging, manufacturing and performance benefits for the vehicle. In terms of packaging, it gives rise to a long, low, flat floor of the van. This allows good use to be made of the internal space of the van and makes it easier to load and unload cargo. Manufacturing and assembly is also improved and will be seen below. Finally, housing heavy powertrain components low down in the underbody 10 improves vehicle dynamics.

The underbody 10 is similar to the arrangement described in PCT/GB2018/052415. Indeed, aspects of that disclosure may be helpful to the skilled reader in understanding the present disclosure and in putting embodiments described herein into effect. As will be seen, the present underbody 10 does however differ from that described in PCT/GB2018/052415.

The underbody 10 is made up of a plurality of sections. Some of these sections are cast aluminium. Some of these sections are aluminium extrusions. Some of the cast sections are substantially the same as each other, having been cast in the same mould, or in moulds designed to be substantially the same. The sections fit together to form the underbody 10. The sections are fixed together by adhesive and by mechanical fixings. Thus, the underbody 10 is modular. The mechanical fixings can be, for example, threaded fasteners engaged with corresponding holes or inserts. The holes or inserts can include a complementary thread for engaging the threaded fasteners, or the threaded fasteners can be configured to form complementary threads in a hole or insert during assembly.

The structural members 100 of the body of the van that are also shown in FIG. 1 will now be described. The structural members 100 form a frame for the body of the van. This frame is to support body panels which are not shown in the figures. The structural members 100 are made up of straight members 110 that extend in the front-to-back direction of the vehicle and u-shaped members 120 that extend up one side of the vehicle, across the top of the vehicle and down the other side—like an inverted u-shape.

FIG. 1 shows three u-shaped members 120. Each of the u-shaped members is the same. This simplifies manufacturing and assembly, and lowers cost. One of the u-shaped members 120 is fixed to the underbody 10 at the back of the vehicle behind the rear wheel arches, another one 120 is fixed just in front of the rear wheel arches and the third one 120 is fixed just behind the front wheel arches.

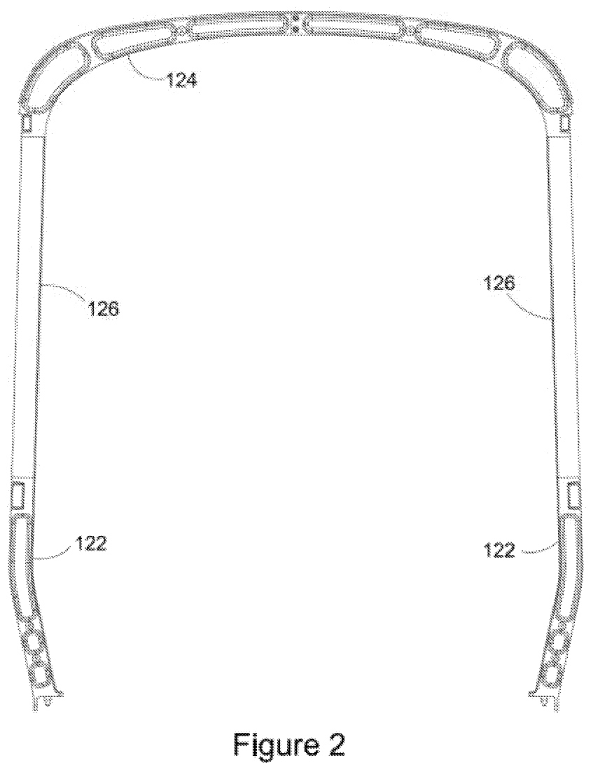

Each u-shaped member 120 is formed of several sections. These will be now described with reference to FIG. 2. Some of the sections are cast from aluminium. Some of the sections are extruded aluminium. The foot section 122 of each u-shaped member 120 that is next to and fixed to the underbody 10 is cast. These foot sections 122 will be described in more detail with reference to the later figures. The top section 124 of each u-shaped member 120 that extends across the top of the vehicle is also cast. Straight pillar sections 126 that extend between each foot section 122 and the associated top section 124 are extruded.

Returning to FIG. 1, the straight members 110 (that make up the frame together with the u-shaped members 120) extend between the u-shaped members 120 in a direction along the length of the vehicle. They are fixed to the u-shaped members 120 using mechanical fixings in the form of threaded fasteners engaging complementary holes or inserts (tapped or untapped).

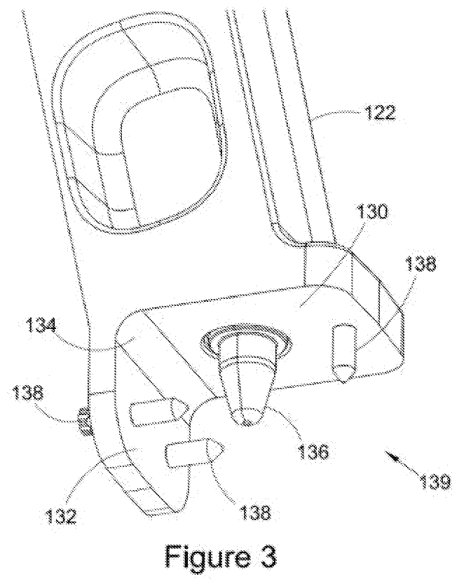

FIG. 3 shows, in more detail, a foot section 122 of one of the u-shaped structural members 120. The foot section 122 is shaped so as to have, at its lowest end, a flat top surface 130 and a flat side surface 132 perpendicular to it. The two surfaces are joined by an internal filet radius 134. The top surface 130 has a conical locating pin 136 mounted in it, tapering towards its tip. The pin 136 can be fitted after casting of the foot section 122, or it can be cast together with the foot section. The material from which the pin 136 is made can be selected to best suit the mode of manufacturing. For example, the pin can be formed of aluminium or plastic. The top surface also has a hole formed in it for receiving a bolt 138. That hole is formed on the side of the conical pin 136 furthest from the radius 134. The side surface 132 has two holes formed in it, each for receiving a bolt 138.

Together, as will be seen, the top surface 130, the side surface 132, the radius 134, the conical locating pin 136 and surrounding surfaces of the foot section 122, all form male mounting structure 139 for mounting the structural members 100 and hence the vehicle body to the underbody 10. The interfacing surfaces of the foot section 122 (and other interfacing regions) can be machined after casting, for example, to increase accuracy of critical dimensions for mating parts.

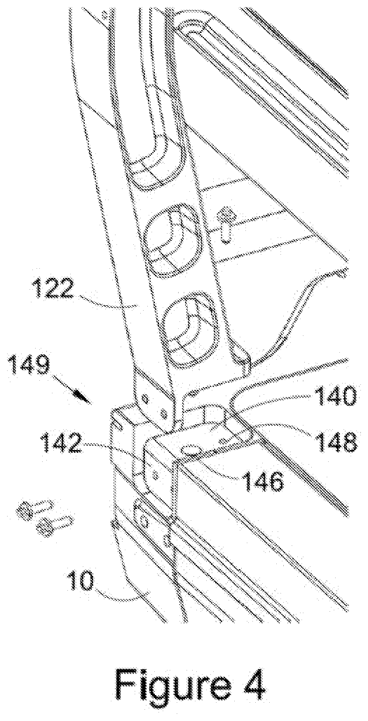

Corresponding mounting structure of the underbody 10 will now be described with reference to FIG. 4. FIG. 4 shows a cast aluminium section of the underbody 10. This section is shaped to form female mounting structure 149. The female mounting structure 149 is shaped to mate with the male mounting structure 139 of the foot section 122 of the vehicle body. The female mounting structure 149 therefore has a recessed top surface 140 to interface with the top surface 130. It also has a recessed side surface 142 to interface with the side surface 132. The top surface 140 of the female mounting structure 149 has a hole 146 formed therein to receive and locate the conical pin 136. The top surface 140 and the side surface 142 have holes formed therein to align with and receive the bolts 130 of the foot section 122. Walls of the female mounting structure 149 that project from the two recessed surfaces 140, 142 to define the associated recesses are shaped and configured to interface with surfaces of the foot section 122 that surround the foot section's top surface 130 and side surface 134 when the two components are mated. The overall arrangement is such that the foot section fits in the underbody 10 with the two mounting structures 139, 149 mating.

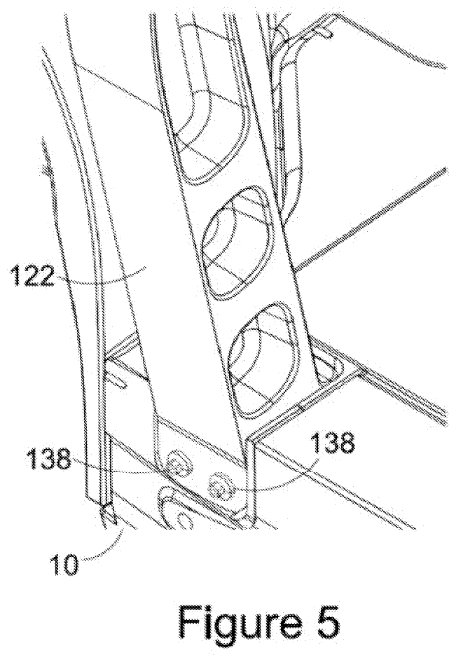

In assembly of the vehicle, and with reference to FIG. 1, the frame of the vehicle is assembled by assembling the structural members 100 to give the arrangement described above. The assembled structural members 100 are then introduced to the underbody 10 such that the male mounting structure 139 of each of the foot sections 122 of the structural members 100 mates with corresponding female mounting structure 149 of the underbody 10. As part of this, the conical locating pins 136 are inserted into the corresponding holes 146 in the underbody 10, bring the foot sections 122 and hence the structural members 100 into correct alignment and location relative to the underbody 10. This arrangement is shown in FIG. 5.

The bolts 138, which in this embodiment are self-tapping bolts, are then fixed into place through the holes in the foot sections 122 into the corresponding holes 148, fixing the combined assembly.

The corresponding and cooperating profiles of the male mounting structure 139 and the female mounting structure 149 result in good location of the structural members 100 relative to the underbody 10 and in providing a high degree of structural support to the combined structure.

In other embodiments it is envisaged that an adhesive, such as glue, may be used to fit the foot sections 122 to the underbody 10.

It is also envisaged that various types of body panel may be used with the structural members 100 described above to form the vehicle body. These may be panels formed of composite material. It is also envisaged that the structural members 100, or their functional equivalents, may be incorporated into a monocoque or part-monocoque body, that body providing the foot sections 122 or the male mounting structure 139 thereof to mate with the female mounting structure 149 of the underbody 10.

In the following section, we will walk-through a simplified variant.

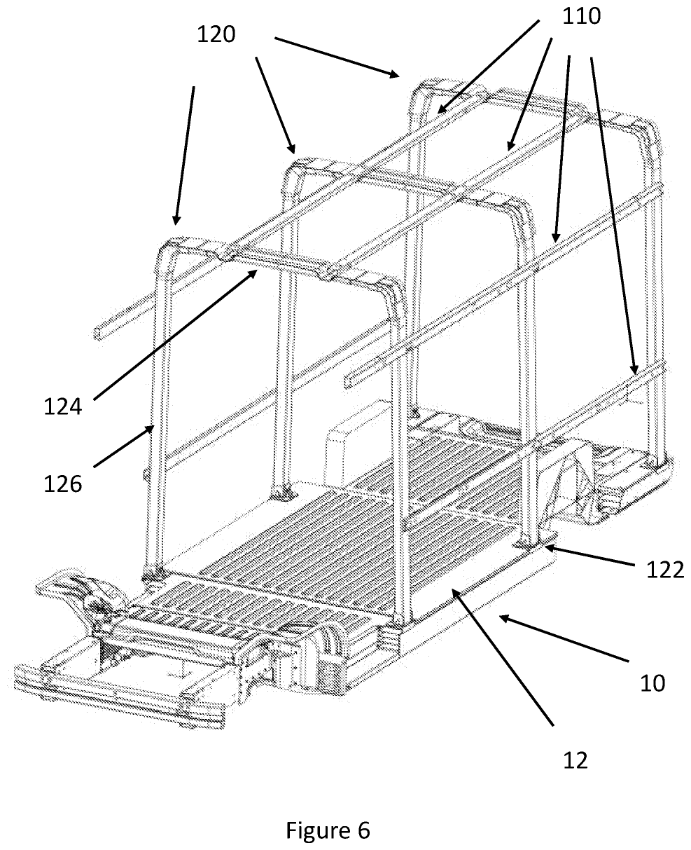

We start with FIG. 6: this shows the underbody or skateboard platform 10, and a set of three u-shaped structural sub-frames 120 (described previously as u-shaped members of the frame). In practice, a vehicle could have two, three, four or more of these u-shaped structural sub-frames 120. The skateboard platform is inherently rigid, with a sufficiently high degree of torsional rigidity that it does not need a structural body; it is sufficiently rigid on its own to provide a stable, driveable platform. Structural sub-frames 120, whilst contributing to the overall structural rigidity of the vehicle, primarily serve as the structural skeleton for the vehicle body. The structural demands on the sub-frames 120 are hence less than they would be if they were an inherent and necessary part of the vehicle's structural integrity.

Each structural sub-frame 120 is made up of a top section or roof bow 124; left and right side straight pillar sections 126 and a foot 122 at the base of each straight pillar sections 126. Each foot 122 rest directly on, and is attached directly to, the skateboard platform 10 and is a single metal casting. In this implementation, there is no specific male and female mounting structures; instead, the underside of the foot 122 forms an open joint and can placed at any suitable position on the top and side of the skateboard platform 10.

The three structural sub-frames 120 are connected together by straight, horizontal bars 110 that give the overall frame (made up of the three u-shaped structural sub-frames 120 and these straight, horizontal bars 110) greater structural integrity.

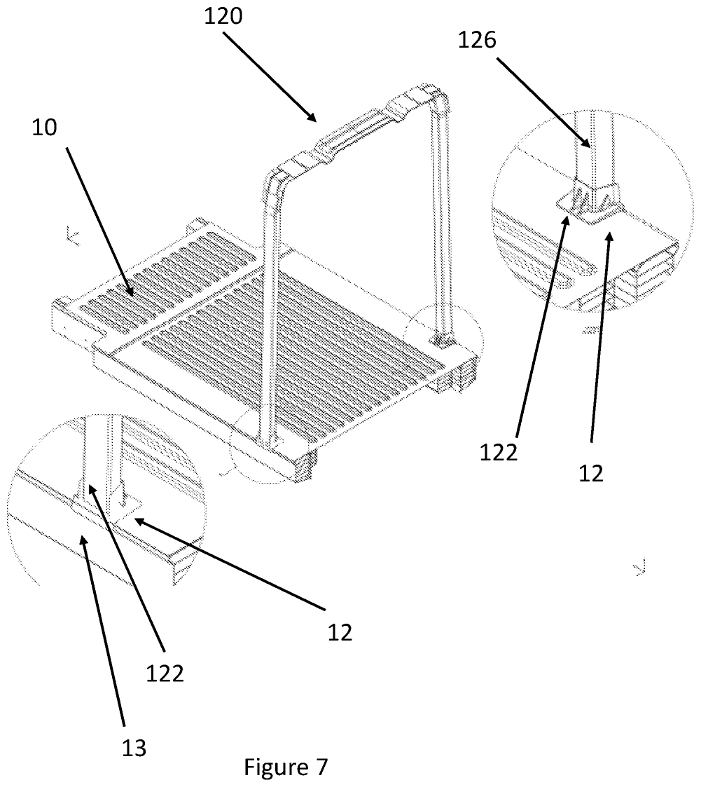

FIG. 7 shows a portion of the skateboard platform 10 and just a single U-shaped structural sub-frame 12. Straight pillar section 126 of the U shaped structural sub-frame 120 is shown inserted into the cast foot 122 at the base of each straight pillar sections 126. Each of the cast feet 122 are positioned directly against, and permanently attached to, the top or upwards-facing surface 12 of the skateboard platform 10 as well as the outward-facing or side surface 13; cast feet 122 are hence mounted against and fold over the external upper edge of the skateboard platform 10. FIG. 8 and FIG. 9 are close up views showing the foot 122 mounted against the outer top edge of the skateboard platform.

This mounting position gives both a high degree of structural integrity, and is also fast and reliable to manufacture: access to the mounting position is very good, since it is on the outside edge of the skateboard platform. An extruded aluminium structural beam defines each outer edge of the skateboard platform and the cast feet 122 are attached directly into this structural beam using adhesive, applied to the open joint defined by the ‘L’ shaped lower surface of the foot 122 and the skateboard platform; mechanical fixings, such as flow-drill screws, are also used; these are passed through holes (122) in the cast foot 122 and are then directly drilled into the extruded aluminium structural beam that defines the outer edge of the skateboard platform 10 to give a permanent fixing.

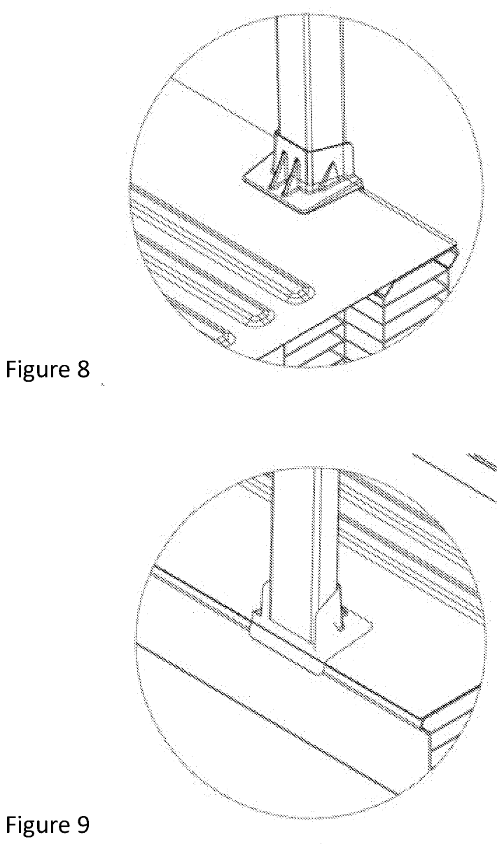

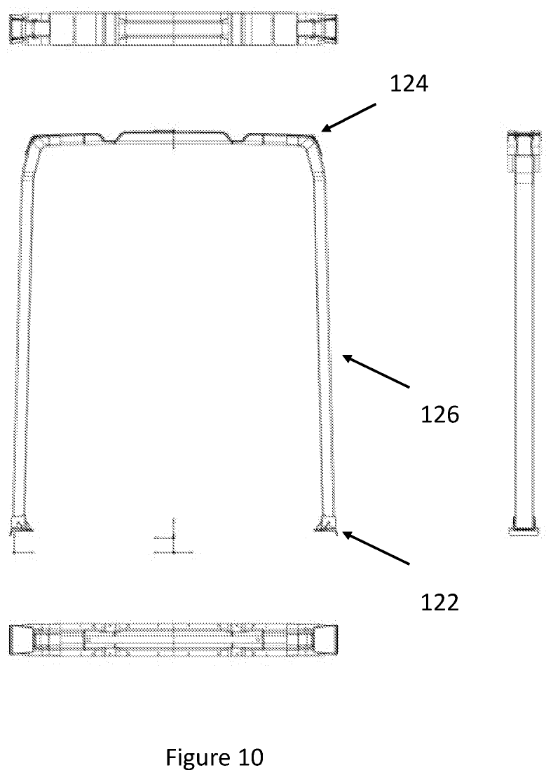

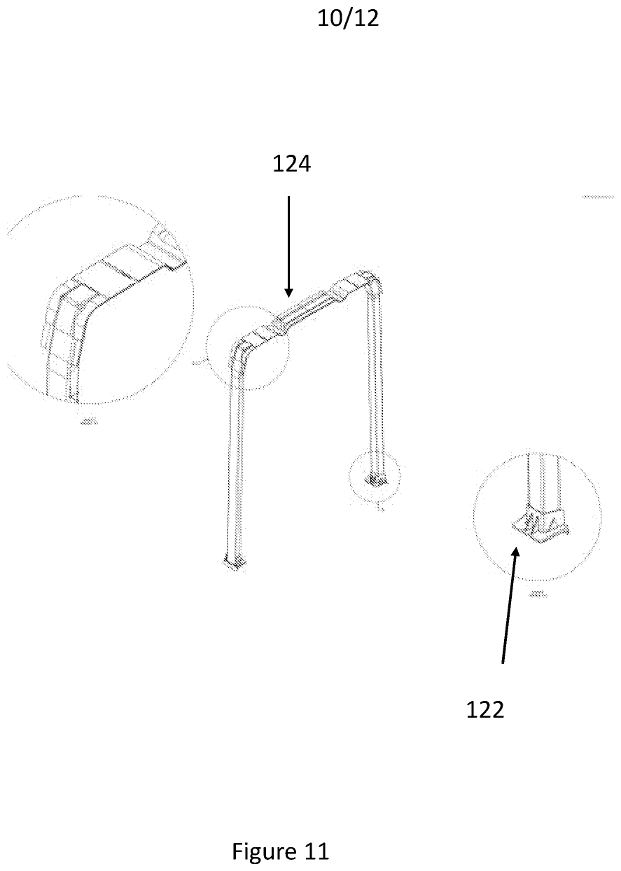

FIG. 10 shows a single U-shaped structural sub-frame 12 from various views (front, top, bottom, side); FIG. 11 is a perspective view. The sub-frame includes cast feet 122, aluminium extruded straight pillars 126 and a roof bow or top section 124, made up of multiple aluminium pressings.

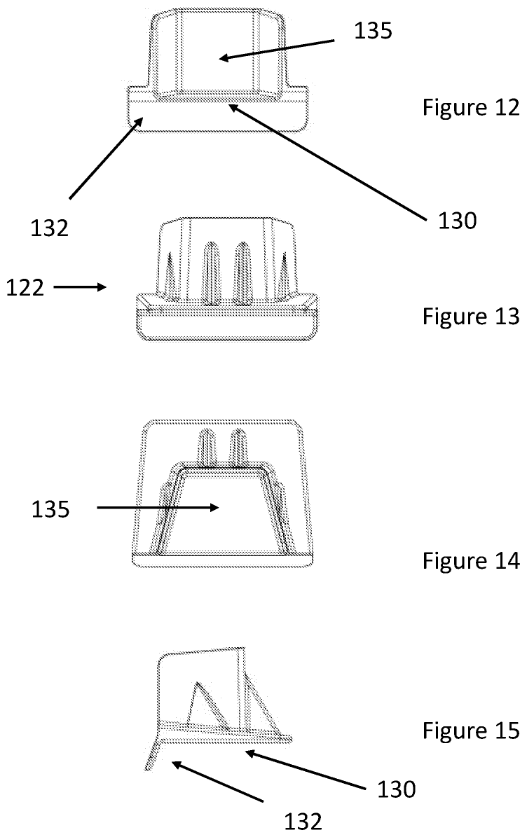

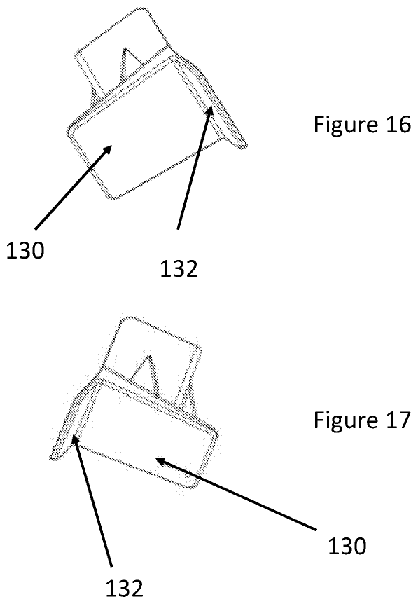

FIGS. 12-17 are views of the foot 122, made of a single metal casting. FIG. 12 is a front view, showing the region 135 into which a straight pillar 126 can be slotted. The base or underside 130 of the foot 122 and the lip 132 that drops down from the back of the foot are shown. Both the base 130 and lip 132 are adhesively attached to the top and side (respectively) of the skateboard platform and are also attached with flow-drill screws. FIG. 13 is a rear view of the foot 122 and FIG. 14 a top down view. FIG. 15 is a side view and FIGS. 16 and 17 are perspective views.

By using the approaches disclosed in this document, better use can be made of the characteristics of an electric power train. In particular, by using the present approaches, the manufacturing and assembly of an electric vehicle can be easier, simpler and less expensive, and a commercial electric vehicle with better packaging and hence better performance as a commercial vehicle can also be provided. This is the case when compared with vehicles based on approaches carried over from and optimised for ICE powertrains.

Appendix 1: Key Features

This Appendix 1 summarises a number of key features. described in this specification. In the following sections, note that any ‘Feature A’-‘Feature F’ can be combined with any other compatible Feature and also any compatible ‘Optional Sub-Feature’ or set of compatible ‘Optional Sub-Features’. And any ‘Optional Sub-Feature’, or set of ‘Optional Sub-Features’ can be combined with any compatible ‘Optional Sub-Feature’ or set of compatible ‘Optional Sub-Features’.

Feature A: An automotive vehicle with a skateboard platform or skateboard chassis and a vehicle body that is attached to the skateboard platform or chassis, in which the sides of the vehicle body are formed using a structural frame, made up of multiple structural sub-frames that give structural integrity to the sides of the vehicle body and to which body panels are attached; and in which each structural sub-frame is directly attached to the skateboard platform or chassis.

Optional Sub-Features

The frame
the frame is attached to an outward-facing side of the skateboard platform or chassis.
the frame is permanently attached to an outward-facing edge of the skateboard platform or chassis.
the frame is permanently attached to an outward-facing side or edge of the skateboard platform or chassis using a robotic system.
the frame is also attached to an upwards facing side and also an outward-facing side of the skateboard platform or chassis
the frame includes pillars or legs that form the sides of the body, and a base or foot of each pillar or leg is directly attached to the top and to the side of the skateboard platform or chassis.
the frame is made up of a series of inverted, substantially ‘U’ shaped, structural sub-frames
the frame is made up of a series of substantially ‘U’ shaped, structural hoops that each form a structural sub-frame
the frame also includes substantially horizontal bars or members, attached to adjacent ‘U’ shaped, structural sub-frames
the substantially horizontal bars or members form part of the sides and/or roof of the vehicle body

The ‘U’ shaped, structural sub-frames
each inverted, substantially ‘U’ shaped, structural sub-frame includes (i) a pair of substantially vertical pillars or legs, defining the left and the right side of the cargo body, each pillar or leg terminating in a foot that is configured to be attached directly to the skateboard platform or chassis and (ii) a roof bar or member joining the pair of substantially vertical legs.
each inverted, substantially ‘U’ shaped, structural sub-frame is configured to be assembled and then moved into position on the skateboard platform or chassis and then attached to the skateboard platform or chassis
the structural sub-frame is configured so that the attachment position on the skateboard platform or chassis is determined when designing the vehicle and there is no pre-set attachment position that applies to all body types.
the skateboard platform or chassis includes a feature, such as a ridge or depression, configured for a structural sub-frame to fit against
each inverted, substantially ‘U’ shaped, structural sub-frame is configured to be moved into position and then attached to the skateboard platform or chassis using a robotic system
each inverted, substantially ‘U’ shaped, structural sub-frame is configured to be attached to the platform of chassis using an open joint system
each inverted, substantially ‘U’ shaped, structural sub-frame is configured to be attached to the platform of chassis using an open joint system in which an adhesive is applied to an open surface of the joint using a robot with a glue injection or glue spreading end effector
each inverted, substantially ‘U’ shaped, structural sub-frame is attached to the platform of chassis using one or more: fixing screws, flow-drill screws, fasteners, adhesives; each adapted for robotic handling
each inverted, substantially ‘U’ shaped, structural sub-frame is attached to the platform of chassis using a self-aligning fixture
the vertical pillars or legs are metal, e.g. aluminium, extrusions
the roof bar or member is made up of one or more metal pressings
structural sub-frames do not provide a base for the vehicle body

The legs
the vertical pillars or legs are extrusions, such as aluminium extrusions

The foot
each foot is a single casting, such as an aluminium casting
each foot is configured to be attached to a vertical pillar or leg
each foot is configured to be attached to the skateboard platform or chassis using an open joint
each foot has a flat section configured to lie against a top or upwards-facing surface of the skateboard platform or chassis
each foot has a flat section configured to lie against a side our outwards-facing surface of the skateboard platform or chassis
each foot has an ‘L’ shaped lower surface, designed to abut against the side and top of the skateboard platform or chassis
each foot is attached to the skateboard platform or chassis using adhesive and multiple flow-drill screws.
each foot is attached to the skateboard platform or chassis using an open joint system and an adhesive is applied to an open surface of the joint using a robot with a glue injection or glue spreading end-effector
each inverted, substantially ‘U’ shaped, structural sub-frame is attached to the platform of chassis using one or more: fixing screws, flow-drill screws, fasteners, adhesives; each adapted for robotic handling
the attachment position of at least one foot on the skateboard platform or chassis is determined when designing the vehicle and there is no pre-set attachment position that applies to all body types.
the skateboard platform or chassis includes a feature, such as a ridge or depression, configured for a foot to fit against
each foot includes a self-aligning feature

The vehicle body
the body can be one of a number of different designs, shapes or types of body, all configured to attach to the skateboard platform or chassis in which each structural sub-frame is directly attached to the skateboard platform or chassis.
the vehicle body is or includes the cargo area of a van
the vehicle body is or includes the passenger area of a bus
the vehicle body is or includes the passenger area of a car

The body panels
individual body panels are configured to attach to the structural sub-frames
the body panels includes at least a portion of a structural sub-frame
at least some of the body panels that individually attach to the structural sub-frames are made of composite material

The skateboard platform or chassis
the skateboard platform or chassis has one or more substantially flat-topped sections that each also have flat sides, and the structural sub-frames attach to the skateboard platform or chassis at these sections.
the skateboard platform or chassis has extruded metal, e.g. extruded aluminium, side members or beams, and the structural sub-frames attach directly to these side members or beams
the skateboard platform or chassis has a substantially flat-topped central section that contains rechargeable battery modules
the skateboard platform or chassis has a substantially flat-topped section that extends at least between the vehicle axles
the top surface of the skateboard platform or chassis is substantially flat and extends over one or more electric traction motors.

The vehicle
the automotive vehicle is a delivery van or a bus
the automotive vehicle is a delivery van and the body includes a cargo body
the vehicle includes two or more inverted, substantially ‘U’ shaped, structural sub-frames
the vehicle includes three or more inverted, substantially ‘U’ shaped, structural sub-frames
the height of the vehicle body is determined by the height of the inverted, substantially ‘U’ shaped, structural sub-frames and different body types, with different heights, can be attached to the same type of skateboard platform or chassis.
the length of the vehicle body is determined by the number of substantially ‘U’ shaped, structural sub-frames used and different body types, with different lengths, can be attached to skateboard platforms or chassis with different lengths.

Feature B: An electric vehicle with a skateboard platform or chassis and a body, in which the sides of the vehicle body are formed using a structural frame to which body panels for the body are attached; and in which the structural frame is directly attached to the skateboard platform or chassis.

Optional Sub-Features
the automobile is a delivery van
the automobile is a bus
the automobile is a car

Feature C: A method of assembling a vehicle with a skateboard platform or chassis and a body, in which the sides of the body are formed using a structural frame made up of multiple structural sub-frames to which body panels are attached; comprising the steps of:

(i) assembling one or more structural sub-frames;

(ii) positioning each structural sub-frame on the skateboard platform or chassis and attaching each directly to the skateboard platform or chassis;

(iii) attaching the panels to the structural sub-frames.

Feature D: A vehicle with: an underbody chassis, the underbody chassis comprising an upper side and a lower side and containing, between the upper side and a lower side, at least one of a battery and an electric motor of an electric powertrain of the vehicle; and
a structural body portion of a vehicle body for fixing to the underbody chassis;
wherein each of the structural body portion and the underbody chassis comprises a plurality of mounting structures, each mounting structure on the structural body portion arranged to directly attach and mate with a respective mounting structure on the underbody chassis.

Optional Sub-Features
the mounting structures on the structural body portion and on the underbody chassis are located to locate the structural body portion relative to the underbody chassis when the respective structures mate.
the mounting structures on the structural body portion and on the underbody chassis are profiled to provide structural support of the structural body portion relative to the underbody chassis when the respective structures mate and when the structural body portion is fixed to the underbody chassis.
the mounting structures on the structural body portion and the mounting structures on the underbody chassis are profiled such that the mating mounting structures have substantially matching profiles.
wherein one of each mating pair of the mounting structures has a male portion that is received in a female portion of the other of the mating pair.
wherein the male portion includes a tapered portion, tapered from its base to its end to help with location during assembly; optionally, the female portion is correspondingly tapered.
the vehicle comprises fixing means to fix the structural body portion to the underbody chassis, the fixing means applied at the interface between each mating pair of mounting structures.
the structural body portion comprises a plurality of structural members, the structural members forming at least part of a structural frame of the body and wherein the structural members comprise some or all of the mounting structures of the vehicle body.
the mounting structures of the structural body portion are formed in ends of the structural members, for example as castings, the mounting structures being at least partly formed by that casting.
the vehicle comprises one or more body panel fixed to the structural members.
the mounting structures of the underbody chassis are formed in structure of the underbody chassis by casting.
the mounting structures of the underbody chassis formed as castings in cast sections of the underbody chassis.
the electric vehicle is a commercial electric vehicle.
the structural body portion is or includes the frame
the structural body portion is or includes a structural sub-frame

Feature E: Components for an electric vehicle, the components comprising: an underbody chassis, the underbody chassis comprising an upper side and a lower side and arranged to contain, between the upper side and a lower side, at least one of a battery and an electric motor of an electric powertrain of the vehicle; and
a structural body portion of a vehicle body for fixing to the underbody chassis;
wherein each of the structural body portion and the underbody chassis comprises a plurality of mounting structures, each mounting structure on the structural body portion arranged to mate with a respective mounting structure on the underbody chassis.

Feature F: A method of assembling an electric vehicle or sub-assembly for an electric vehicle as defined in any aspect above. According to the fifth aspect, the method may be a method for assembling a structural body portion and an underbody chassis for an electric vehicle, the method comprising:
mounting the structural body portion to the underbody chassis such that the mounting structures on the structural body portion mate with the mounting structures on the underbody chassis;
and fixing the structural body portion to the underbody chassis.

1. An automotive vehicle with a skateboard platform or skateboard chassis and a vehicle body that is attached to the skateboard platform or chassis, in which the sides of the vehicle body are formed using a structural frame, made up of multiple structural sub-frames that give structural integrity to the sides of the vehicle body and to which body panels arc attached: and in which each structural sub-frame is directly attached to the skateboard platform or chassis.

2-4. (canceled)

5. The vehicle of claim 1 in which the frame is at least one of:
attached to an outward-facing side of the skateboard platform or chassis;
permanently attached to an outward-facing edge of the skateboard platform or chassis;
permanently attached to an outward-facing side or edge of the skateboard platform or chassis using a robotic system; or
attached to an upwards facing side and an outward-facing side of the skateboard platform or chassis.

6. The vehicle of claim 1 in which at least one of:
the frame is made up of a series of inverted, substantially ‘U’ shaped, structural sub-frames;
the frame includes substantially horizontal bars or members, attached to adjacent ‘U’ shaped, structural sub-frames; or
the frame includes pillars or legs that form the sides of the body, and a base or foot of each pillar or leg is directly attached to the top and to the side of the skateboard platform or chassis.

7-10. (canceled)

11. The vehicle of claim 1 in which each inverted, substantially ‘U’ shaped, structural sub-frame includes (i) a pair of substantially vertical pillars or legs, defining the left and the right side of the cargo body, each pillar or leg terminating in a foot that is configured to be attached directly to the skateboard platform or chassis and (ii) a roof bar or member joining the pair of substantially vertical legs.

12. (canceled)

13. The vehicle of claim 1 in which the structural sub-frame is configured so that the attachment position on the skateboard platform or chassis is determined when designing the vehicle and there is no pre-set attachment position that applies to all body types.

14. The vehicle of claim 1 in which the skateboard platform or chassis includes a feature, such as a ridge or depression, configured for a structural sub-frame to fit against.

15-17. (canceled)

18. The vehicle of claim 1 in which each inverted, substantially ‘U’ shaped, structural sub-frame at least one of:
is configured to be assembled and then moved into position on the skateboard platform or chassis and then attached to the skateboard platform or chassis;
is configured to be moved into position and then directly attached to the skateboard platform or chassis using a robobtic system;
is configured to be attached to the platform of chassis using an open joint system;
is configured to be directly attached to the platform of chassis using an open joint system in which an adhesive is applied to an open surface of the joint using a robot with a glue injection or glue spreading end effector;
is attached to the platform of chassis using a self-aligning fixture; or
is directly attached to the platform of chassis using one or more: fixing screws, flow-drill screw s, fasteners, adhesives, each adapted for robotic handling.

19-21. (canceled)

22. The vehicle of claim 1 in which structural sub-frames do not provide a base for the vehicle body.

23. The vehicle of claim 1 in which the vertical pillars or legs are extrusions.

24-30. (canceled)

31. The vehicle of claim 1 in which each foot at least one of:
is a single casting;
includes a self-aligning feature;
is configured to be attached to a vertical pillar or leg;
is configured to be attached to the skateboard platform or chassis using an open joint;
has a flat section configured to lie against a top or upwards-facing surface of the skateboard platform or chassis;
has a flat section configured to lie against a side our outwards-facing surface of the skateboard platform or chassis,
has an ‘L’ shaped lower surface designed to abut against the side and top if the skateboard platform or chassis;
is attached to the skateboard platform or chassis using adhesive and multiple flow-drill screws; or
is attached to the skateboard platform or chassis using an open joint system and an adhesive is applied to an open surface of the joint using a robot with a glue injection or glue spreading end-effector.

32. (canceled)

33. The vehicle of claim 1 in which the attachment position of at least one foot on the skateboard platform or chassis is determined when designing the vehicle and there is no pre-set attachment position that applies to all body types.

34. The vehicle of claim 1 in which the skateboard platform or chassis includes a feature, such as a ridge or depression, configured for a foot to fit against.

35. (canceled)

36. The vehicle of claim 1 in which the body can be one of a number of different designs, shapes or types of body, all configured to attach to the skateboard platform or chassis in which each structural sub-frame is directly attached to the skateboard platform or chassis.

37. (canceled)

38. (canceled)

39. The vehicle of claim 1 in which the vehicle body is or includes.
the cargo area of a van;
the passenger area of a bus; or
the passenger area of a car.

40. (canceled)

41. (canceled)

42. The vehicle of claim 1 in which, at least one of:
individual body panel are configured to attach to the structural sub-flames;
the body panels include at least a portion of a structural sub-frame; or
at least some of the body panels that individually attach to the structural sub-frames are made of composite material.

43. (canceled)

44. The vehicle of claim 1 in which at least one of:
the skateboard platform or chassis has one or more substantially flat-topped sections that each also have flat sides, and the structural sub-frames attach to the skateboard platform or chassis at these sections;
the skateboard platform or chassis has a substantially flat-topped central section that contains rechargeable battery modules;
the skateboard platform or chassis has a substantially flat-topped section that extends at least between the vehicle axles;
the top surface of the skateboard platform or chassis is substantially flat and extends over one or more electric traction motors; or
the skateboard platform or chassis has extruded metal side members or beams, and the structural sub-frames attach directly to these side members or beams.

45-49. (canceled)

50. The vehicle of claim 1 in which the vehicle includes two or more inverted, substantially ‘U’ shaped, structural sub-frames.

51. (canceled)

52. The vehicle of claim 1 in which at least one of:
the height of the vehicle body is determined by the height of the inverted, substantially ‘U’ shaped, structural sub-frames and different body types, with different heights, can be attached to the same type of skateboard platform or chassis; or
the length of the vehicle body is determined by the number of substantially ‘U’ shaped, structural sub-frames used and different body types, with different lengths can be attached to skateboard platforms or chassis with different lengths.

53. (canceled)

54. An electric vehicle with a skateboard platform or chassis and a body, in which the sides of the vehicle body are formed using a structural frame to which body panels for the body are attached;
and in which the structural frame is directly attached to the skateboard platform or chassis.

55. A method of assembling a vehicle with a skateboard platform or chassis and a body, in which the sides of the body are formed using a structural frame made up of multiple structural sub-frames to which body panels are attached; comprising the steps of:
(i) assembling one or more structural sub-frames;
(ii) positioning each structural sub-frame on the skateboard platform or chassis and attaching each directly to the skateboard platform or chassis;
(iii) attaching the panels to the structural sub-frames.
